(19) United States
(12) Patent Application Publication
(10) Pub. No.: US 2022/0385876 A1
(43) Pub. Date: Dec. 1, 2022

(54) IMAGE PROCESSING APPARATUS, CONTROL METHOD THEREOF, AND STORAGE MEDIUM

(71) Applicant: CANON KABUSHIKI KAISHA, Tokyo (JP)

(72) Inventor: Takuto Kawahara, Tokyo (JP)

(21) Appl. No.: 17/750,456

(22) Filed: May 23, 2022

(30) Foreign Application Priority Data
May 27, 2021 (JP) 2021-089463

(51) Int. Cl. H04N 13/106; H04N 13/111; H04N 13/167; H04N 13/282

(52) U.S. Cl. CPC H04N 13/158; H04N 13/111; H04N 13/167; H04N 13/282

(57) ABSTRACT

An image processing apparatus obtains information that on a first video and a second video at least one of which is a captured video obtained by an image capturing apparatus, the information related to the first and second videos includes information on first and second viewpoints corresponding to the first and second videos of a same timing. The image processing apparatus, in a case where switching a video to be outputted from the first video to the second video, generates information on a virtual viewpoint corresponding to a period from an end of output of the first video until a start of output of the second video, based on the obtained information on the first viewpoint corresponding to the period and the obtained information on the second viewpoint corresponding to the period.

### BACKGROUND

### Field

The present disclosure relates to an image processing apparatus, a control method thereof, and a storage medium.

### Description of the Related Art

Recently, a technique for generating a virtual viewpoint video using a multi-viewpoint video obtained by installing a plurality of cameras at different positions and synchronously capturing from multiple viewpoints by has been attracting attention. For example, Japanese Patent Laid-Open No. 2008-015756 discloses a technique for generating an image of an arbitrary viewpoint using images of an object captured by a plurality of cameras that are arranged so as to surround the object. According to such a technique for generating a virtual viewpoint video from a multi-viewpoint video, a highlight scene of a soccer or a basketball game, for example, can be viewed from various angles, thereby making it possible to give a viewer a greater sense of presence than a normal video. In addition, with music event capturing or live distribution, music videos, and the like, it is possible to create videos that capture artists from various angles.

With music event capturing or live distribution, and capturing of a music video, or the like, a plurality of videos that are simultaneously obtained from a plurality of cameras are used by switching them. For example, a first camera captures so-called “zoom-out videos” from long-shot videos that include the periphery of an object to shots of an object from the chest up. In addition, for example, a second camera captures so-called “close-up videos” from videos of an object from the chest up to close-up shots. Then, by using the videos captured by the first camera and the second camera by switching them, it is possible to generate a video that supports the sizes of various objects. At this time, for example, it is considered that the first camera is a virtual viewpoint (referred to as a virtual camera in the present specification) for generating the above-described virtual viewpoint video, and the second camera is an actual camera (referred to as a real camera in the present specification) that captures images that are not used for the virtual viewpoint video.

Generally, in a video switching apparatus that switches between two videos and outputs one video, since a video is instantly switched to another video, the video changes greatly when switching. Therefore, a viewer may feel a sense of unnaturalness. As a method for reducing the sense of unnaturalness in the viewer when videos are switched, it is known to add video effects, such as a fade-in and a fade-out, when switching videos. However, a video by the first camera and a video by the second camera are still used when switching, and therefore, it is impossible to avoid the occurrence of an unnatural change in a video caused by the switching of videos.

### SUMMARY

According to an aspect of the present disclosure, there is provided a technique for reducing an unnatural change in a video for when two videos are outputted by being switched.

According to one aspect of the present disclosure, there is provided an image processing apparatus comprising: one or more memories configured to store instructions; and one or more processors configured to, upon executing the instructions: obtain information on a first video and a second video at least one of which is a captured video obtained by an image capturing apparatus, the information related to the first video including information on a first viewpoint corresponding to the first video, and the information related to the second video including information on a second viewpoint corresponding to the second video at a timing that corresponds to a timing of the first video; in a case where switching a video to be outputted from the first video to the second video, generate information on a virtual viewpoint corresponding to a period from an end of output of the first video until a start of output of the second video, based on the obtained information on the first viewpoint corresponding to the period and the obtained information on the second viewpoint corresponding to the period; generate a virtual viewpoint video based on the generated information on the virtual viewpoint; and output the first video, the generated virtual viewpoint video, and the second video in that order.

According to another aspect of the present disclosure, there is provided a method of controlling an image processing apparatus, the method comprising: obtaining information on a first video and a second video at least one of which is a captured video obtained by an image capturing apparatus, the information related to the first video including information on a first viewpoint corresponding to the first video, and the information related to the second video including information on a second viewpoint corresponding to the second video at a timing that corresponds to a timing of the first video; in a case where switching a video to be outputted from the first video to the second video, generating information on a virtual viewpoint corresponding to a period from an end of output of the first video until a start of output of the second video, based on the obtained information on the first viewpoint corresponding to the period and the obtained information on the second viewpoint corresponding to the period; generating a virtual viewpoint video based on the generated information on the virtual viewpoint; and outputting the first video, the generated virtual viewpoint video and the second video in that order.

According to another aspect of the present disclosure, there is provided a non-transitory computer-readable storage medium operable to store a program for causing a computer to execute a method of controlling an image processing apparatus, the method comprising: obtaining information on a first video and a second video at least one of which is a captured video obtained by an image capturing apparatus, the information related to the first video including information on a first viewpoint corresponding to the first video, and the information related to the second video including information on a second viewpoint corresponding to the second video at a timing that corresponds to a timing of the first video; in a case where switching a video to be outputted from the first video to the second video, generating information on a virtual viewpoint corresponding to a period from an end of output of the first video until a start of output of the second video, based on the obtained information on the first viewpoint corresponding to the period and the obtained information on the second viewpoint corresponding to the period; generating a virtual viewpoint video based on the generated information on the virtual viewpoint; and outputting the first video, the generated virtual viewpoint video, and the second video in that order.

Further features of the present disclosure will become apparent from the following description of exemplary embodiments with reference to the attached drawings.

### BRIEF DESCRIPTION OF THE DRAWINGS

FIG. 1 is a diagram illustrating an example of an overall configuration of an image processing system according to a first embodiment.

FIG. 2 is a flowchart for explaining processing of deciding a video to be distributed according to the first embodiment.

FIG. 3 is a diagram illustrating a timeline for switching from a virtual viewpoint video to a real camera video.

FIGS. 4A to 4G are diagrams illustrating examples of generation of virtual camera information according to the first embodiment.

FIG. 5 is a diagram illustrating another example of generation of the virtual camera information according to the first embodiment.

FIGS. 6A to 6C are diagrams illustrating an operation unit for designating a switching ratio according to the first embodiment.

FIG. 7 is a diagram illustrating an example of an overall configuration of the image processing system according to a second embodiment.

FIG. 8 is a flowchart for explaining the processing of deciding a video to be distributed according to the second embodiment.

FIGS. 9A to 9F are diagrams illustrating examples of generation of the virtual camera information according to the second embodiment.

FIG. 10 is a block diagram illustrating an example of a hardware configuration of the image processing apparatus.

### DESCRIPTION OF THE EMBODIMENTS

Hereinafter, embodiments will be described in detail with reference to the accompanying drawings. The following embodiments are not intended to limit the present disclosure. Although embodiments describe multiple features, not all of these multiple features are essential to the disclosure, and multiple features may be arbitrarily combined. Furthermore, in the accompanying drawings, the same reference numerals are assigned to the same or similar components, and a repetitive description thereof is omitted.

### First Embodiment

Hereinafter, an image processing apparatus for switching a video to be outputted from a video of a first viewpoint to a video of a second viewpoint will be described. In the first embodiment, the first viewpoint is a viewpoint of a virtual image capturing apparatus for generating a virtual viewpoint video from a plurality of images captured by a plurality of image capturing apparatuses, and the second viewpoint is a viewpoint of a physical image capturing apparatus for capturing a video. That is, a video of the first viewpoint is a virtual viewpoint video, and a video of the second viewpoint is a video by a real camera (hereinafter, a real camera video). In the following, an example in which, in an image processing system for generating a virtual viewpoint video, when switching from a virtual viewpoint video to a real camera video, a new virtual viewpoint video for smoothly connecting the two videos is generated will be described.

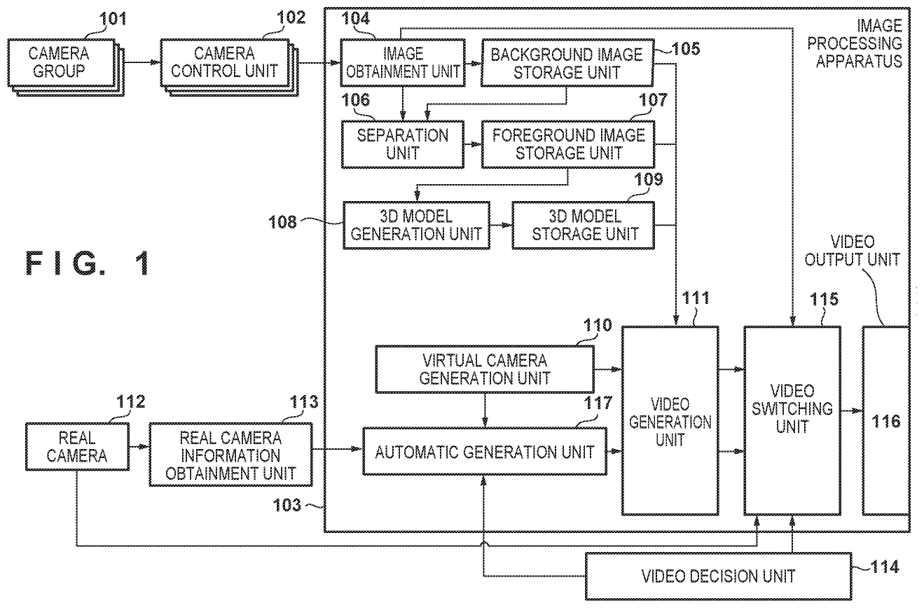

FIG. 1 is a block diagram illustrating an example of a configuration of the image processing system for generating a virtual viewpoint video according to a first embodiment. In order to generate a virtual viewpoint video, a camera group 101 is configured by a plurality of image capturing apparatuses (hereinafter, referred to as cameras) for obtaining a multi-viewpoint image of an image capturing range. Each of the plurality of cameras includes an image capturing element, and in front thereof is provided a lens. The plurality of cameras are installed and fixed around the image capturing range facing the image capturing range. A camera control unit 102 controls each camera of the camera group 101. The camera control unit 102 is provided for each camera of the camera group 101 and is connected to each camera of the camera group 101 by a camera control cable and a camera image output cable. The plurality of camera control units 102 are connected to each other via a local network cable or the like in a daisy chain, for example, and transmit images of the camera group 101 to an image processing apparatus 103 that is connected downstream. The network configuration for connecting the plurality of camera control units 102 is not limited to a daisy chain and may be a star network configuration in which each camera control unit is connected to the image processing apparatus.

The image processing apparatus 103 has a function of generating and outputting a virtual viewpoint video, which is a video from a virtual viewpoint, based on images (a multi-viewpoint image) obtained by the camera group 101. Hereinafter, a functional configuration of the image processing apparatus 103 will be described.

An image obtainment unit 104 obtains, from the camera control unit 102, captured images (a multi-viewpoint image) obtained by the camera group 101. The image obtainment unit 104 acquires in advance, as background images, the captured images obtained by the camera group 101 capturing the image capturing region in which an image capturing target (foreground) is not included and stores them in a background image storage unit 105. A separation unit 106 separates, from the captured images in which the image capturing region is captured, the image capturing target (foreground) included in those images. The separation unit 106 performs separation by, for example, a background difference. More specifically, the separation unit 106 separates the foreground and the background by comparing the background images, which have been obtained in advance and then stored in the background image storage unit 105, and the captured images and specifying the differences as the foreground, which is the image capturing target. The separation unit 106 stores images (hereinafter referred to as foreground images) that include the separated foreground in a foreground image storage unit 107. The method for separating the foreground and the background used by the separation unit 106 is not limited to the above-described separation method, which uses the background difference, and a well-known separation method, such as a separation method that uses a distance image, for example, can be used.

The foreground image storage unit 107 stores a plurality of foreground images (a plurality of foreground images obtained by a plurality of cameras (i.e., a plurality of viewpoints)), which have been separated by the separation unit 106 from the images captured by the camera group 101 installed around the image capturing region. A 3D model generation unit 108 obtains the foreground images from the foreground image storage unit 107 and generates a 3D model of the foreground. The 3D model generation unit 108 generates a 3D model of the foreground using a visual volume intersection method from, for example, the foreground images obtained at a plurality of viewpoints. The generated 3D model of the foreground and its position information are stored in a 3D model storage unit 109.

A virtual camera generation unit 110 generates virtual camera information in accordance with user operation for instructing a position, a direction of a view, or the like of a virtual viewpoint, which is received from a user interface such as a joystick or various input units. The virtual camera information includes information on a position, an orientation (a view direction), and an angle of view (focal distance) and time information on a virtual viewpoint of a virtual viewpoint video (hereinafter, also referred to as a virtual camera). That is, the function of the virtual camera generation unit 110 generates the information for each time of the virtual viewpoint, which is necessary for generating a virtual viewpoint video, in accordance with the operation of the virtual camera by an operator using an input unit, such as a joystick.

A video generation unit 111 generates a virtual viewpoint video based on the time, the position, the orientation, and the angle of view of the virtual camera, which are indicated by the virtual camera information generated by the virtual camera generation unit 110 or an automatic generation unit 117 which will be described later. For example, in order to generate a virtual viewpoint video, the video generation unit 111 obtains the foreground images of a corresponding time from the foreground image storage unit 107 and a 3D model of the foreground of the corresponding time from the 3D model storage unit 109 and then generates a foreground image that corresponds to the position, orientation, and angle of view of the virtual camera. The video generation unit 111 obtains the background images stored in the background image storage unit 105 and a 3D model of the background, which has been provided in advance, and then generates a background image corresponding to the position, orientation, and angle of view of the virtual camera. The video generation unit 111 combines the generated foreground image and background image and then outputs it as a virtual viewpoint video. The virtual viewpoint video is provided to a video switching unit 115 and becomes one of the candidates for a video to be outputted as a final video.

A real camera 112 is a camera capable of capturing the image capturing range of the virtual camera independent of the camera group 101. The real camera 112 is used not for obtaining images that are necessary for a virtual viewpoint video but for capturing an object in close-up. In the present embodiment, the name, real camera, is used to distinguish the real camera from the camera group 101, which is for obtaining images that are necessary for a virtual viewpoint video, and the virtual camera, which does not exist in reality but is virtually arranged at a position from which the virtual viewpoint video is obtained. A captured video obtained by the real camera 112 is provided to the video switching unit 115, which will be described later, and becomes one of the candidates for a video to be outputted as the final video.

A real camera information obtainment unit 113 obtains information that includes a position, an orientation (a view direction), and an angle of view (focal distance) of the real camera 112. The real camera information obtainment unit 113 estimates the position and orientation of the real camera 112 from, for example, a position of a marker disposed in a range of movement of the real camera 112 in an image captured by the real camera 112. However, the present disclosure is not limited to this; for example, an image of the marker may be obtained by connecting, to the real camera 112, a camera for capturing the marker for position estimation separately from the real camera. Alternatively, a configuration may be taken so as not to arrange the marker but estimate the position and orientation of the real camera 112 by specifying, from an image captured by the real camera 112, a characteristic point whose position is known.

A video decision unit 114 selects and decides an output video from a plurality of candidates for an output video. The video decision unit 114 includes an input unit such as switches for selecting video output and a fader for adjusting the volume or the like. It is also possible to perform switching with various video effects (transitions) for when switching videos. For example, it is possible to decide to output a virtual viewpoint video, switch from the virtual viewpoint video to a real camera video, or decide to add a video effect such as fade-in or fade-out when switching. The video decision unit 114 transmits, to the video switching unit 115, channel information for designating a selected video, and information that indicates a video effect to be executed when switching. The video switching unit 115 selects a video from the video candidates based on the information from the video decision unit 114 and outputs it to a video output unit 116. The video output unit 116 outputs the video supplied from the video switching unit 115 to an external unit.

When switching an output video from a video of the virtual camera to a video of the real camera, the automatic generation unit 117 automatically generates virtual camera information for obtaining a virtual viewpoint video that connects the videos before and after switching. The virtual camera information generated by the automatic generation unit 117 is one of the video effects for when switching videos and, when the positions, the orientations (directions of lines of sight), and the angles of view (focal distances (zoom values)) of the virtual camera and the real camera are different, automatically generates new virtual camera information from the virtual camera information and the real camera information to make the change in an image when switching videos smoother.

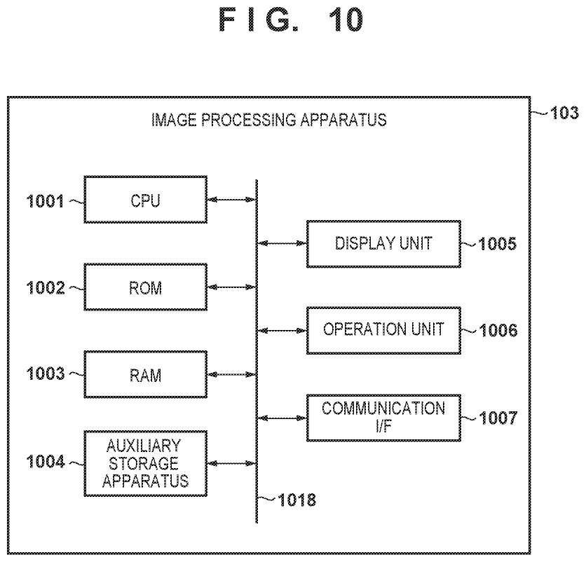

Next, a hardware configuration of the image processing apparatus 103 for realizing the above functional configuration will be described with reference to FIG. 10. The image processing apparatus 103 includes a CPU (central processing unit) 1001, a ROM (read-only memory) 1002, a RAM (random access memory) 1003, an auxiliary storage apparatus 1004, a display unit 1005, an operation unit 1006, a communication I/F 1007, and a bus 1018.

The CPU 1001 realizes the functions of the image processing apparatus 103 illustrated in FIG. 1 by controlling the entire image processing apparatus 103 using a computer program or data stored in the ROM 1002 or the RAM 1003. The image processing apparatus 103 may have one or a plurality of dedicated pieces of hardware that is different from the CPU 1001, and the dedicated hardware may execute at least a part of the processing by the CPU 1001. Examples of dedicated hardware include an ASIC (application specific integrated circuit), an FPGA (field programmable gate array), a DSP (digital signal processor), and the like. The ROM 1002 stores programs that do not need to be changed and the like. The RAM 1003 temporarily stores programs and data supplied from the auxiliary storage apparatus 1004, data supplied from an external unit via the communication I/F 1007, and the like. The auxiliary storage apparatus 1004 is configured by, for example, a hard disk drive or the like and stores various kinds of data such as image data and voice data.

The display unit 1005 is configured by, for example, a liquid crystal display, LEDs, and the like and displays a GUI (Graphical User Interface) for the user to operate the image processing apparatus 103 and the like. The operation unit 1006 is configured by, for example, a keyboard, a mouse, a joystick, a touch panel, and the like and inputs various instructions to the CPU 1001 in response to operation by a user. The communication I/F 1007 is used for communication with a device that is external to the image processing apparatus 103. For example, when the image processing apparatus 103 is connected to an external apparatus by wire, a cable for communication is connected to the communication I/F 1007. When the image processing apparatus 103 has a function of wirelessly communicating with an external apparatus, the communication I/F 1007 is provided with an antenna. The bus 1018 transmits information by connecting the respective units of the image processing apparatus 103.

In the present embodiment, it is assumed that the display unit 1005 and the operation unit 1006 are present inside the image processing apparatus 103, but at least one of the display unit 1005 and the operation unit 1006 may be present outside the image processing apparatus 103 as another apparatus. In such a case, the CPU 1001 may operate as a display control unit for controlling the display unit 1005 and an operation control unit for controlling the operation unit 100.

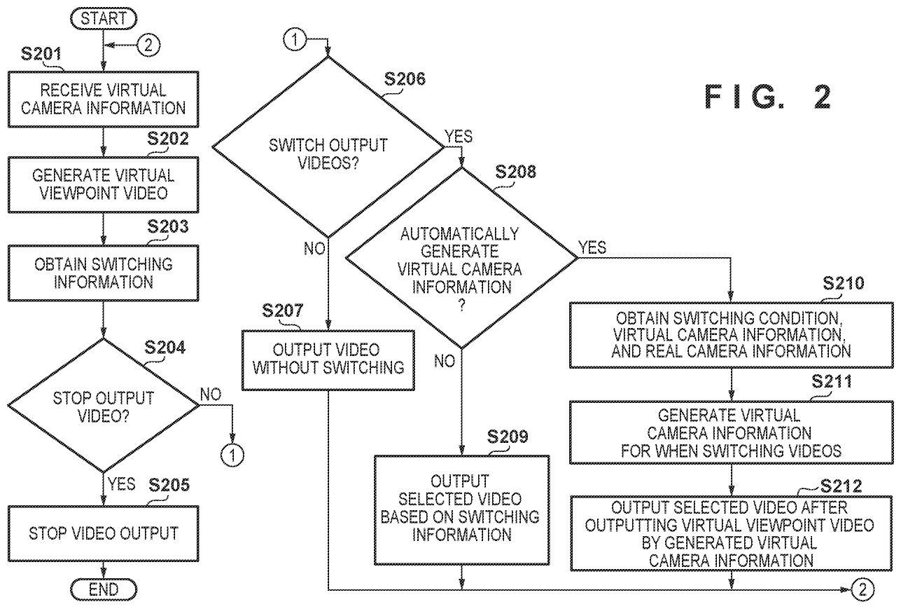

Next, the processing for when videos of the virtual camera and the real camera are switched by the image processing apparatus 103 having the above configuration will be described with reference to FIG. 2. FIG. 2 is a flowchart for explaining processing of deciding an output video by the image processing apparatus of the first embodiment. In FIG. 2, the processing of storing the background images obtained by the image obtainment unit 104 in the background image storage unit 105 and the processing of storing the foreground images separated by the separation unit 106 in the foreground image storage unit 107 are omitted.

In step S201, the video generation unit 111 obtains the virtual camera information generated by the virtual camera generation unit 110. In step S202, the video generation unit 111 generates a virtual viewpoint video based on the obtained virtual camera information. In step S203, the video switching unit 115 obtains the switching information for the output video from the video decision unit 114. The switching information indicates, for example, a channel of the output video after switching, a switching time, and the like that have been decided by the video decision unit 114. In step S204, the video switching unit 115 determines whether to stop the output video based on the switching information obtained in step S203. When it is determined to stop the output video (YES in step S204), in step S205, the video switching unit 115 stops outputting the video. If it is determined not to stop the output video (NO in step S204), the processing proceeds to step S206.

In step S206, the video switching unit 115 determines whether to switch the output video based on the switching information obtained in step S203. When it is determined not to switch the output video (NO in step S206), in step S207, the video switching unit 115 continues to output the video without switching the output video. Then, the processing returns to step S201. Meanwhile, if it is determined to switch the output video (YES in step S206), the processing proceeds to step S208.

In step S208, the video switching unit 115 determines whether or not the virtual camera information is automatically generated when the output video is switched. When it is determined that the virtual camera information is not automatically generated (NO in Step S208), in step S209, the video switching unit 115 immediately switches the video to be outputted to the video output unit 116 based on the switching information to the video after switching indicated by the switching information. For example, a switch is performed from a virtual viewpoint video generated by the video generation unit 111 to a real camera video captured by the real camera 112 using a virtual viewpoint generated by the virtual camera generation unit 110. Then, the processing returns to step S201. Meanwhile, if it is determined to automatically generate the virtual camera information (YES in step S208), the processing proceeds to step S210.

The switching information from the video decision unit 114 is also provided to the automatic generation unit 117. In step S210, the automatic generation unit 117 obtains the switching condition from the switching information received from the video decision unit 114. The switching condition includes, for example, information on a transition period indicating a period (a start time and an end time) for automatically generating the virtual camera information. The automatic generation unit 117 obtains the virtual camera information and the real camera information, which are necessary for generating a virtual viewpoint, from the real camera information obtainment unit 113 and the virtual camera generation unit 110, respectively. In step S211, the automatic generation unit 117 generates, based on the virtual camera information, the real camera information, and the switching condition, information (virtual camera information) on a new virtual viewpoint for when switching videos. In step S212, the video generation unit 111 generates a virtual viewpoint video based on the virtual viewpoint newly generated by the automatic generation unit 117. After outputting the virtual viewpoint video obtained from the new virtual viewpoint, the video switching unit 115 starts outputting a selected video (in the present example, a real camera video). Then, the processing returns to step S201.

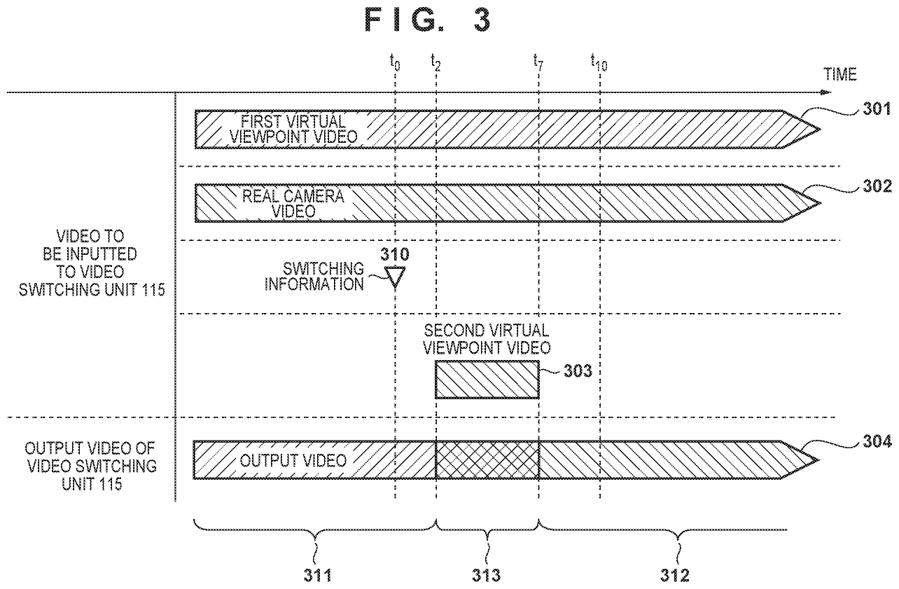

The relationship between the virtual viewpoint video, the real camera video, and the output video at each elapsing of time for when switching the output video from the virtual camera to the real camera will be described below with reference to FIG. 3. FIG. 3 is a diagram illustrating a timeline of processing for switching videos in the first embodiment. In FIG. 3, a first virtual viewpoint video 301 is a virtual viewpoint video generated by the video generation unit 111 based on the virtual camera information generated by the virtual camera generation unit 110 (also referred to as first virtual camera information). A real camera video 302 is a video captured and then outputted by the real camera 112. A second virtual viewpoint video 303 is a virtual viewpoint video generated by the video generation unit 111 based on the virtual camera information generated by the automatic generation unit 117 (also referred to as second virtual camera information). An output video 304 is a video to be selected from the first virtual viewpoint video 301, the real camera video 302, and the second virtual viewpoint video 303, which are candidate videos, and then outputted by the video switching unit 115. The horizontal axis represents time.

The video generation unit 111 generates and then outputs the first virtual viewpoint video 301 in accordance with the virtual camera information generated by the virtual camera generation unit 110 in response to a virtual camera operation by the operator. The real camera 112 also outputs the real camera video 302 that it has captured. Regarding the real camera 112, the position, orientation, zooming, and the like during image capturing is operated by the cameraman. At time t0, the video decision unit 114 outputs, to the video switching unit 115, switching information 310 indicating to switch from the first virtual viewpoint video 301 to the real camera video 302 after t2−t0 seconds using the second virtual viewpoint video 303 over t7−t2 seconds. In the example of FIG. 3, a period from time t2 when the output of the first virtual viewpoint video is ended, to time t7 when the output of the real camera video 302 starts is set as a transition period.

The switching information 310 received by the video switching unit 115 instructs to switch the output video from the first virtual viewpoint video 301 to the real camera video 302 and use the second virtual viewpoint video 303 as a switching condition. The second virtual viewpoint video 303 is a virtual viewpoint image generated by the video generation unit 111 based on the virtual camera information generated by the automatic generation unit 117. In the switching condition, times t2 to t7 are set as a transition period for switching videos (a period for outputting the second virtual viewpoint video).

When the switching information 310, which includes the switching condition as described above, is outputted from the video decision unit 114, it is determined YES in steps S206 and S208 of FIG. 2. Upon receiving the switching condition, the automatic generation unit 117 generates a new virtual viewpoint (also referred to as a second virtual viewpoint) for creating the second virtual viewpoint video 303 for switching from the first virtual viewpoint video 301 to the real camera video 302 over times t2 to t7. More specifically, first, the automatic generation unit 117 obtains the virtual camera information from the virtual camera generation unit 110 and the real camera information from the real camera information obtainment unit 113 in order to create information on a virtual viewpoint from times t2 to t7. The virtual camera information includes information on the position, the view direction of, and the angle of view of the virtual viewpoint used by the video generation unit 111 to generate the first virtual viewpoint video 301. The real camera information includes information on the position, the orientation, and the angle of view of the real camera 112, which is capturing the real camera video 302. Until time t2, the video switching unit 115 selects the first virtual viewpoint video 301 and outputs it to the video output unit 116. At time t2, the video switching unit 115 switches the video to be outputted to the video output unit 116 from the first virtual viewpoint video 301 to the second virtual viewpoint video 303. Further, at time t7, the video switching unit 115 switches the video to be outputted to the video output unit 116 from the second virtual viewpoint video 303 to the real camera video 302. The video output unit 116 outputs the video transmitted from the video switching unit 115.

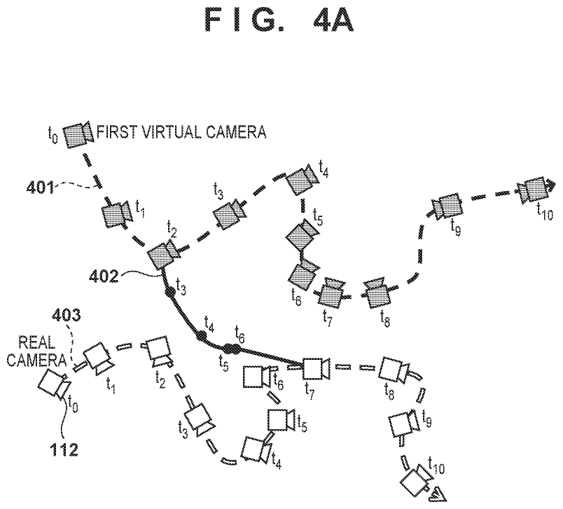

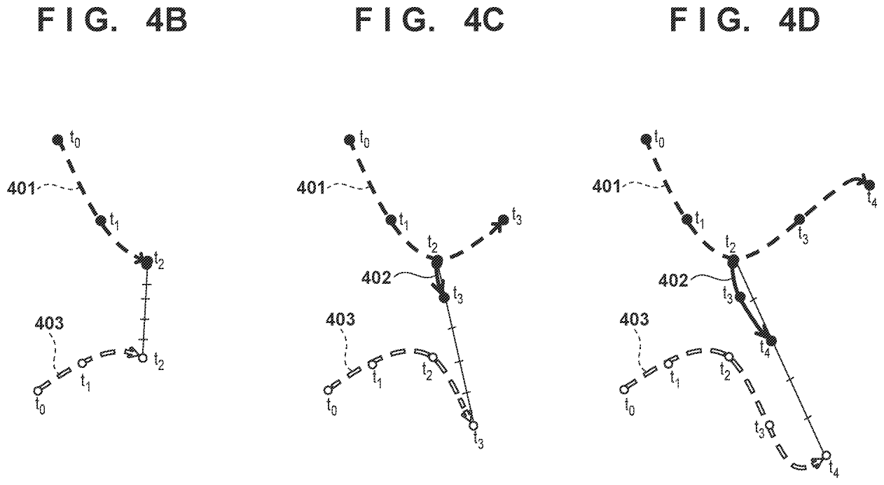

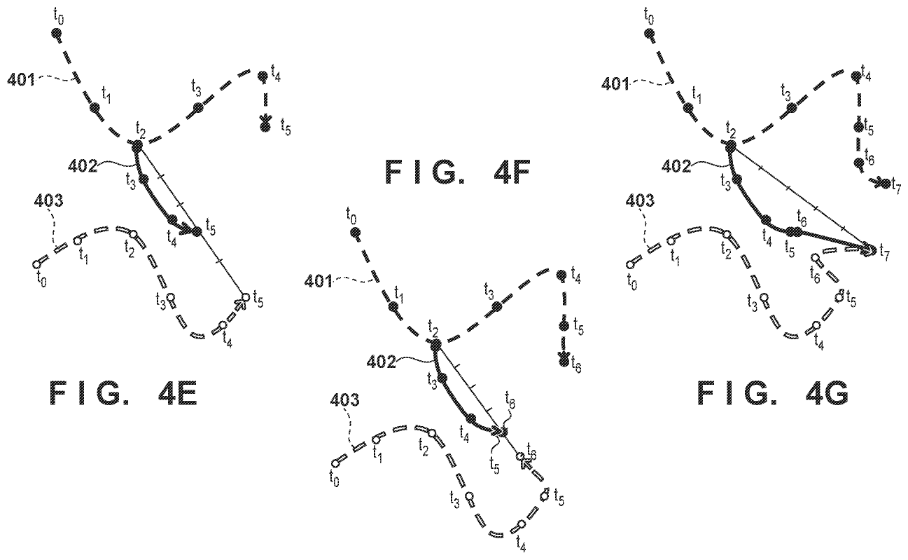

An example of processing for automatically generating virtual camera information by the automatic generation unit 117 will be described in detail with reference to FIGS. 4A to 4G. FIGS. 4A to 4G are examples of processing for automatically generating virtual camera information in the first embodiment. FIG. 4A illustrates the positions and orientations at each time between times t0 and t10 of a virtual camera for generating the first virtual viewpoint video 301, a virtual camera for generating the second virtual viewpoint video 303, and the real camera 112 for capturing the real camera video 302. Although the positions of the virtual camera and the real camera will be described below, other camera information (orientation, zooming state, and the like) can be calculated in the same manner. The timeline from t0 to t10 corresponds to the timeline illustrated in FIG. 3.

In FIGS. 4A to 4G, first virtual camera information 401 indicates using a black dashed arrow the positions indicated by the position information of a first virtual camera generated by the virtual camera generation unit 110. Between t0 and t10, the first virtual camera moves moment by moment in the direction of the arrow along the black dashed arrow. Real camera information 403 indicates using a white dashed arrow the positions indicated by the position information of the real camera 112 obtained by the real camera information obtainment unit 113. Between t0 and t10, the real camera 112 moves moment by moment in the direction of the arrow along the white dashed arrow. Starting from the virtual camera information at time t2, the automatic generation unit 117 generates second virtual camera information 402 so as to gradually approach the real camera information at each time. In FIGS. 4A to 4G, the movement of a second virtual camera by the second virtual camera information 402 is indicated by a black solid arrow.

Hereinafter, a method in which the automatic generation unit 117 generates the position of the second virtual camera from the position of the first virtual camera and the position of the real camera 112, which move moment by moment, will be described with reference to FIGS. 4B to 4G. Hereinafter, an example in which the information on the second virtual viewpoint is generated based on the information on the first virtual camera, the information on the real camera, and a ratio of an elapsed time from when the transition period started to a total time of the transition period will be described.

FIG. 4B illustrates the positions of the first virtual camera, the real camera 112, and the second virtual camera at time t2. At time t2, the position of the second virtual camera and the position of the first virtual camera are the same. FIG. 4C illustrates the positions of the first virtual camera, the real camera 112, and the second virtual camera at time t3. The position of the second virtual camera at time t3 is decided based on the ratio of the elapsed time (t3−t2) to the total time (t7−t2) of the transition period. More specifically, the position of the second virtual camera at time t3 is at a position advancing from the first virtual camera toward the real camera 112 by the ratio of (t3−t2)/(t7−t2) on a line segment connecting the position of the first virtual camera at time t2 and the position of the real camera 112 at time t3. In other words, the position of the second virtual camera during the transition period is generated by taking a weighted-average of the position of the first virtual viewpoint and the position of the real camera 112 based on the ratio. FIG. 4D illustrates the positions of the first virtual camera, the real camera 112, and the second virtual camera at time t4. The position of the second virtual camera at time t4 is generated in the same manner as time t3. That is, the position of the second virtual camera at time t4 is at a position advancing from the first virtual camera toward the real camera 112 by the ratio of (t4−t2)/(t7−t2) on a line segment connecting the position of the first virtual camera at time t2 and the position of the real camera 112 at time t4.

FIG. 4E illustrates the positions of the first virtual camera, the real camera 112, and the second virtual camera at time t5. The position of the second virtual camera at time t5 is generated in the same manner as time t3. That is, the position of the second virtual camera at time t5 is at a position advancing from the first virtual camera toward the real camera 112 by the ratio of (t5−t2)/(t7−t2) on a line segment connecting the position of the first virtual camera at time t2 and the position of the real camera 112 at time t5. FIG. 4F illustrates the positions of the first virtual camera, the real camera 112, and the second virtual camera at time t6. The position of the second virtual camera at time t6 is also generated in the same manner as described above. That is, it is at a position advancing from the first virtual camera toward the real camera 112 by the ratio of (t6−t2)/(t7−t2) on a line segment connecting the position of the first virtual camera at time t2 and the position of the real camera 112 at time t6. FIG. 4G illustrates the positions of the first virtual camera, the real camera 112, and the second virtual camera at time t7. The position of the second virtual camera at time 7 is at a position advancing from the first virtual camera toward the real camera 112 by the ratio of (t7−t2)/(t7−t2) on a line segment connecting the position of the first virtual camera at time t2 and the position of the real camera 112 at time t7. That is, at time t7, which is the end time of the transition period, the position of the second virtual camera and the position of the real camera 112 are the same.

As described above, by virtue of the first embodiment, when switching from the virtual viewpoint video by the first virtual camera to the real camera video by the real camera 112, the transition period of time t2 to time t7 is set. Then, during this transition period, the information on the second virtual camera moving from the position of the first virtual camera to the position of the real camera 112 is generated based on the information on the first virtual camera and the information on the real camera during the transition period. Therefore, when switching from the video of the first virtual camera to the video of the real camera 112, even if the positions of the first virtual camera and the real camera are apart, it is possible to automatically generate information on a virtual camera that interpolates between them during the transition period. As a result, it is possible to provide video without the sense of unnaturalness when switching from the video of the virtual camera to the video of the real camera. Although the processing of switching from the virtual camera video to the real camera video has been described, the same processing as described above can be applied to the case of switching from the real camera video to the virtual camera video. In such a case, the position of the second virtual camera at an initial time of the transition period is the same position as the real camera 112, and the position of the second virtual camera gradually approaches the position of the first virtual camera.

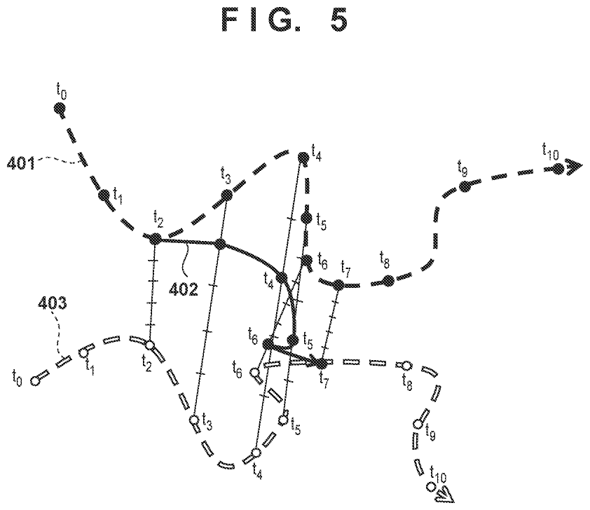

In FIGS. 4A to 4G, the position of the second virtual camera in the transition period is independent of the position of the first virtual camera except at the start of the transition period and gradually approaches the position of the real camera but is not limited to this. For example, the second virtual camera information 402 may be automatically generated using a technique as illustrated in FIG. 5.

FIG. 5 illustrates another example of the method of generating a virtual camera path of the virtual viewpoint video in the first embodiment. Similarly to FIGS. 4A to 4G, FIG. 5 illustrates the positions of the first virtual camera, the second virtual camera, and the real camera 112 at each time between times t0 and t10. In the present example, a method of generating the information on the second virtual camera using the information on the first virtual camera and the real camera 112 at the same time in order to generate the second virtual camera information 402 will be described. Similarly to the processing described in FIGS. 4A to 4G, at time t2, the position of the first virtual camera and the position of the second virtual camera are the same.

The position of the second virtual camera at time t3 is at a position advancing from the first virtual camera toward the real camera 112 by the ratio of (t3−t2)/(t7−t2) on a line segment connecting the positions of the first virtual camera and the real camera 112 at time t3. Similarly, the position of the second virtual camera at time t4 is at a position advancing from the first virtual camera toward the real camera 112 by the ratio of (t4−t2)/(t7−t2) on a line segment connecting the positions of the first virtual camera and the real camera 112 at time t4. Similarly, the position of the second virtual camera at time t5 is at a position advancing from the first virtual camera toward the real camera 112 by the ratio of (t5−t2)/(t7−t2) on a line segment connecting the positions of the first virtual camera and the real camera 112 at time t5. Similarly, the position of the second virtual camera at time t6 is at a position advancing from the first virtual camera toward the real camera 112 by the ratio of (t6−t2)/(t7−t2) on a line segment connecting the positions of the first virtual camera and the real camera 112 at time t6. Similarly, the position of the second virtual camera at time t7 is at a position advancing from the first virtual camera toward the real camera 112 by the ratio of (t7−t2)/(t7−t2) on a line segment connecting the positions of the first virtual camera and the real camera 112 at time t7. As described in FIG. 4G, at time t7, which is the end time of the transition period, the position of the second virtual camera and the position of the real camera 112 are the same.

As described above, in the technique illustrated in FIG. 5, the position of the virtual camera for when switching from the virtual viewpoint video by the first virtual camera to the real camera video by the real camera 112 is calculated based on the positions of the first virtual camera and the real camera 112 at the same time. By virtue of this technique, when switching from the virtual camera video to the real camera video or from the real camera video to the virtual camera video, the position of the second virtual camera is always calculated from the position of the first virtual camera and the real camera 112 at the same time. Therefore, even if, part way through moving from the position of the first virtual camera to the position of the real camera 112, the second virtual camera changes direction to go from the position of the real camera toward the position of the virtual camera, there is no sense of unnaturalness, and it is possible to perform a switch without the sense of unnaturalness.

In the method of automatically generating the two above-described pieces of virtual camera information, the start time and the end time for switching the videos are designated, but the present disclosure is not limited to this, and the start time for switching and the time required for switching (length of the transition period) may be designated. Thus, it is easy to designate in advance the time required for switching or unify the switching time for when generating identical video.

In the method of automatically generating the two above-described pieces of virtual camera information, the movement of the second virtual camera for when switching videos is decided based on the ratio of the elapsed time to a movement period, but the present disclosure is not limited to this. For example, instead of the above-described ratio of the elapsed time to the movement period, a ratio (hereinafter, referred to as a transition ratio) designated by user operation may be used at each time in the transition period. For example, the video decision unit 114 may be provided with an input unit for designating a video before switching and a video after switching and having a fader capable of designating the transition ratio, and the position of the second virtual viewpoint may be generated in response to user operation on the input unit.

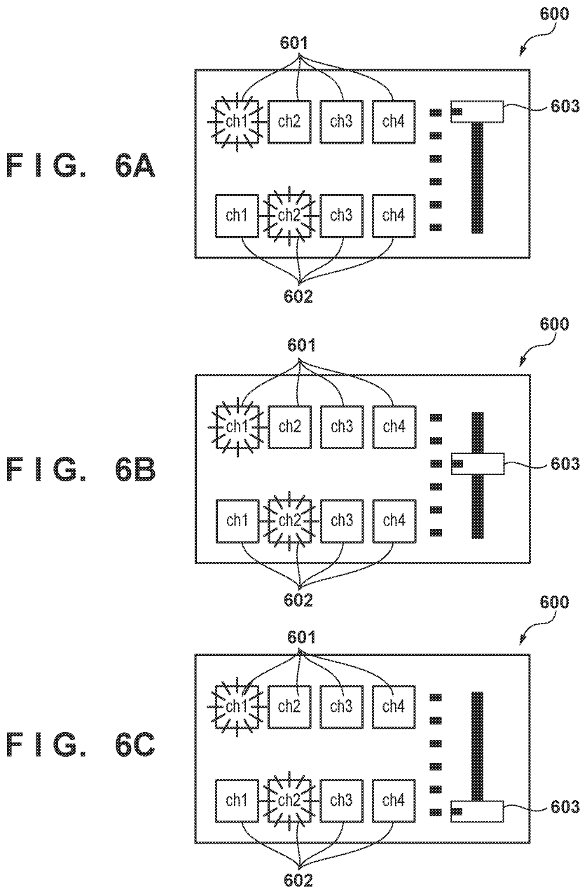

FIGS. 6A to 6C illustrate examples of an input unit 600 on which the transition ratio can be designated. The user operation by the input unit 600 is outputted to the video decision unit 114. The input unit 600 has pre-switchover button switches 601 and post-switchover button switches 602 and is provided with button switches from each of channels 1 to 4. A fader 603 is provided so as to span the pre-switchover button switches 601 and the post-switchover button switches 602. The fader 603 moves in accordance with user operation and instructs the transition ratio for when switching videos in accordance with its position. In the present embodiment, the virtual viewpoint video by the first virtual camera is allocated to the channel 1 and the real camera video by the real camera 112 is allocated to the channel 2.

In FIG. 6A, the fader 603 is at the uppermost position, and in such a case, the video of the channel designated by the pre-switchover button switches 601 is outputted. The pre-switchover button switches 601 of the channel 1 is lit, which indicates that the video of the channel 1 (the first virtual viewpoint video 301) is selected as the video to be outputted from the video switching unit 115. Meanwhile, the channel 2 is selected in the post-switchover button switches 602, and so the channel 2 is lit. This indicates that the channel 2 (the real camera video 302) is selected as the video to be outputted after the switch. When the fader 603 is moved from the uppermost level in a lower direction, the output video is switched from the virtual viewpoint video by the first virtual camera to the second virtual viewpoint video by the second virtual camera. The position of the second virtual camera is generated in the manner described above with reference to FIGS. 4A to 4G or FIG. 5 based on the transition ratio that accords with the position of the fader 603. The transition ratio may be set based on, for example, a distance from the uppermost position to the lowermost position of the fader 603 and a distance from the uppermost position to the current position of the fader 603.

In the example of FIG. 6B, the fader 603 is at a position that is ⅖ between the uppermost and lowermost levels. In this case, the position of the second virtual camera is a position advancing from the first virtual camera toward the real camera 112 by ⅖ of a line segment on the line segment connecting the position of the first virtual camera and the position of the real camera 112 at that time (similar to FIG. 4D). The time at which the movement of the fader 603 is started from the state of FIG. 6A is the start time of the above-described transition period, and the time at which the fader 603 reaches the lowermost level as illustrated in FIG. 6C is the end time of the transition period. That is, when the fader 603 reaches the lowermost level, the video of the second virtual camera switches to the video of the real camera 112, and thereby the switching of videos is completed.

As described above, the operation of the fader 603 makes it possible to designate the transition ratio to be used by the automatic generation unit 117 to generate the virtual camera information when switching videos. Therefore, it is possible to easily operate the switching time and the speed at which the virtual camera approaches the state of the real camera.

Although switching from the virtual viewpoint video to the real camera video has been described above, the present disclosure is not limited to this, and the above processing can be applied to switching from the real camera video to the virtual viewpoint video. That is, either the first viewpoint for obtaining a video before switching or the second viewpoint for obtaining a video after switching is a viewpoint of a virtual image capturing apparatus for generating a virtual viewpoint video, and the other may be a viewpoint of a physical image capturing apparatus for capturing a video. In such a case, the real camera video is switched to the virtual viewpoint video by the second virtual camera and then is further switched to the virtual viewpoint video by the first virtual camera. The virtual viewpoint video is generated as if virtual viewpoint camera information 2 is switched to virtual viewpoint camera information 1. Further, even when switching between two virtual viewpoint videos by two virtual viewpoints or switching between two real camera videos by two real cameras, it is possible to use a virtual viewpoint video from the second virtual camera generated by the automatic generation unit 117.

As described above, by virtue of the first embodiment, when switching from the first video obtained from the first viewpoint to the second video obtained from the second viewpoint, a new virtual camera is generated so as to interpolate between the first viewpoint and the second viewpoint. Then, by using a virtual viewpoint video by a new virtual viewpoint between the first video and the second video, it becomes possible to realize switching in which it seems as though the first video and the second video after switching have been captured from one viewpoint (camera). In addition, by smoothly switching between the virtual viewpoint video and the video of the real camera, it enables a more dynamic video expression which cannot be captured by the real camera.

### Second Embodiment

In the first embodiment, the processing of generating the information on the virtual viewpoint (second virtual camera) based on the information on the first virtual camera and the information on the real camera has been described. The information on the virtual viewpoint includes a position, an orientation (a view direction), a focal distance (a zoom value), and the like, but in the processing of the first embodiment, these are generated by same processing without particular distinction. In the second embodiment, the position information and the orientation information of the information on the virtual viewpoint are generated by independent processing. Configurations that are the same as those of the first embodiment are denoted by the same reference numerals, and detailed description thereof is omitted.

As described above, in the first embodiment, the position information of the second virtual camera is generated so as to move between the first virtual camera and the real camera 112 based on their position information, and the orientation of the second virtual camera can be generated by the same method. However, in the method of the first embodiment, there is a problem that an object that one wishes to capture may not be included in the image capturing range of the second virtual camera depending on the orientation and focal distance of the second virtual camera. In the second embodiment, in order to solve such a problem, information on the position of the second virtual camera and the orientation and the focal distance of the second virtual camera are independently controlled.

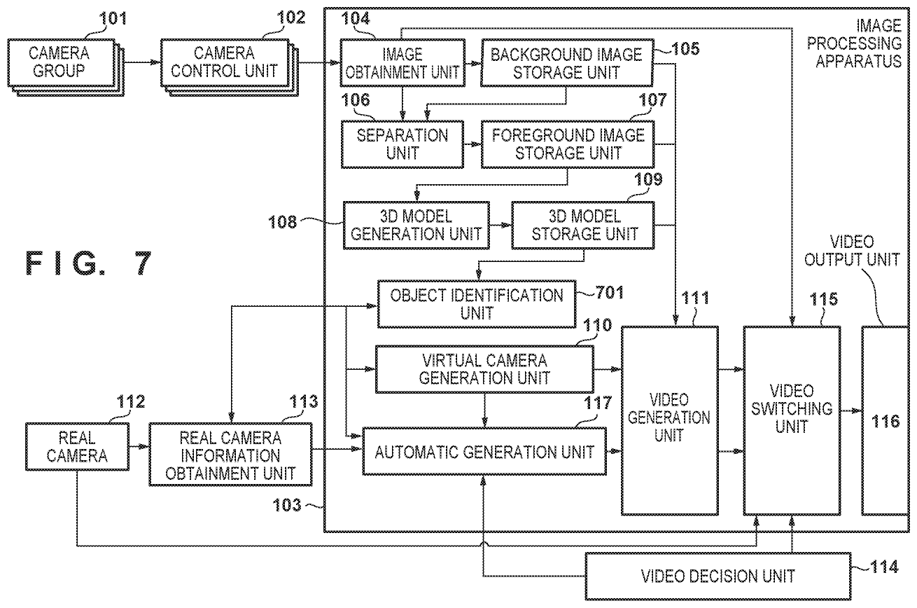

FIG. 7 is a block diagram illustrating an example of a configuration of the image processing system according to a second embodiment. A configuration is taken such that an object identification unit 701 is added to the configuration of the first embodiment (FIG. 1). The object identification unit 701 specifies an object being captured by the virtual camera or the real camera 112. That is, the object identification unit 701 identifies an object that is captured in the video of the virtual camera or the real camera 112 based on the camera information from the virtual camera generation unit 110, the real camera information obtainment unit 113, and the automatic generation unit 117 and the information from the 3D model storage unit 109. Further, the image obtainment unit 104 also provides the videos obtained from the camera control unit 102 to the video switching unit 115. Thus, it becomes possible for the video switching unit 115 to use, as video output, the videos of the camera group 101 used for the virtual viewpoint video.

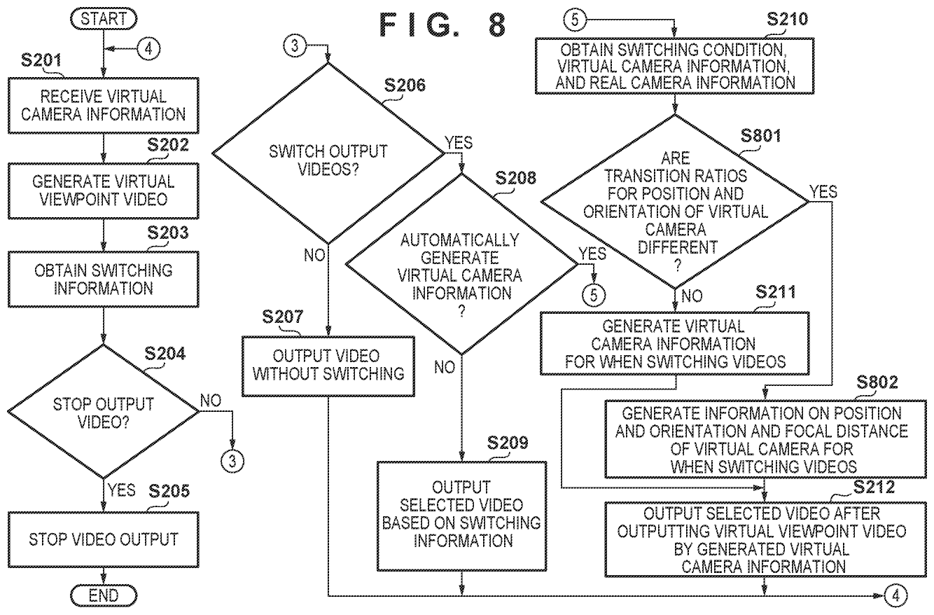

FIG. 8 is a flowchart for explaining the processing of deciding an output video according to the second embodiment. Processing that is the same as those of the first embodiment (FIG. 2) are denoted by the same step numbers. In step S801, the automatic generation unit 117 refers to the switching information and determines whether the transition ratios of the position and the orientation of the second virtual camera are different during the period of transition from the first virtual viewpoint video 301 to the real camera video 302. If it is determined that the transition ratios are not different (NO in step S801), the processing proceeds to step S211. Meanwhile, if it is determined that the transition ratios are different (YES in step S801), the processing proceeds to step S802.

In step S802, the automatic generation unit 117 generates information on the position, the orientation, and the angle of view of the second virtual camera for when switching from the virtual camera video to the real camera video based on the information on the first virtual camera, the information on the real camera 112, and the switching condition. The automatic generation unit 117 obtains a transition period for position for switching from the position of the first virtual camera to the position of the real camera 112 included in the switching condition, and a transition period for orientation for switching from the orientation of the first virtual camera to the orientation of the real camera 112. In the switching condition, for example, the transition period of the position and the transition period of the orientation are set independently of each other, and are indicated by the start time and the end time, respectively. The automatic generation unit 117 calculates the position and the orientation of the second virtual camera at each time. Similarly to the first embodiment, the input unit 600 including the fader 603 for designating the switching ratio may be used. In such a case, the fader 603 is individually provided for each condition that one wishes to independently control.

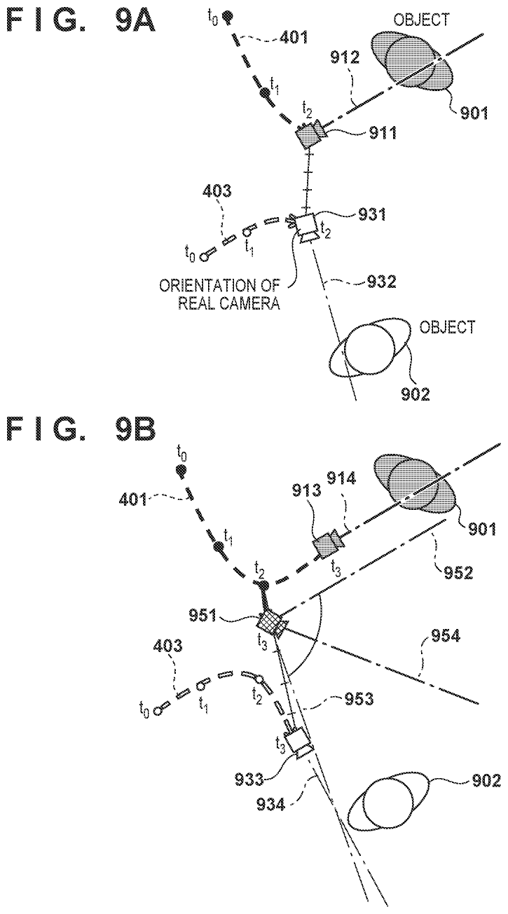

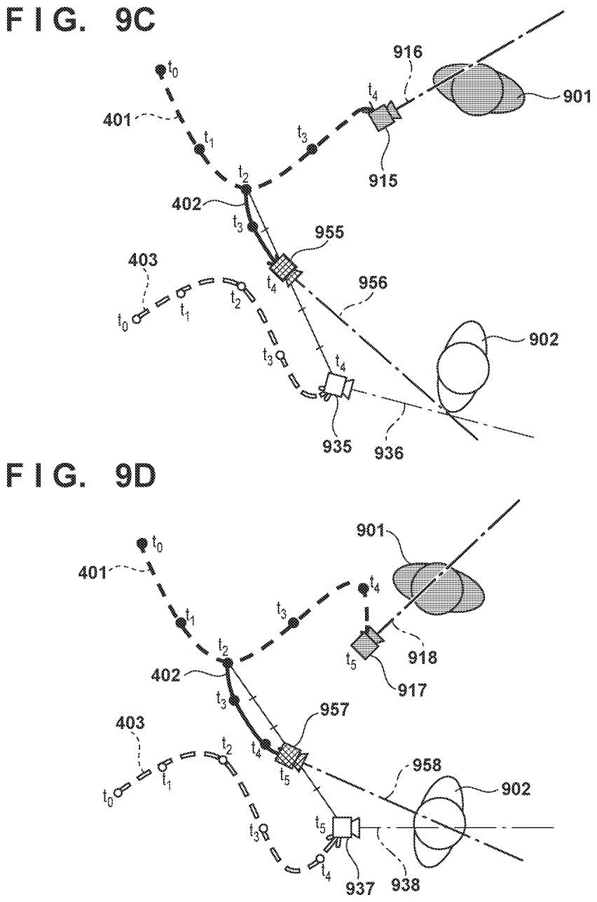

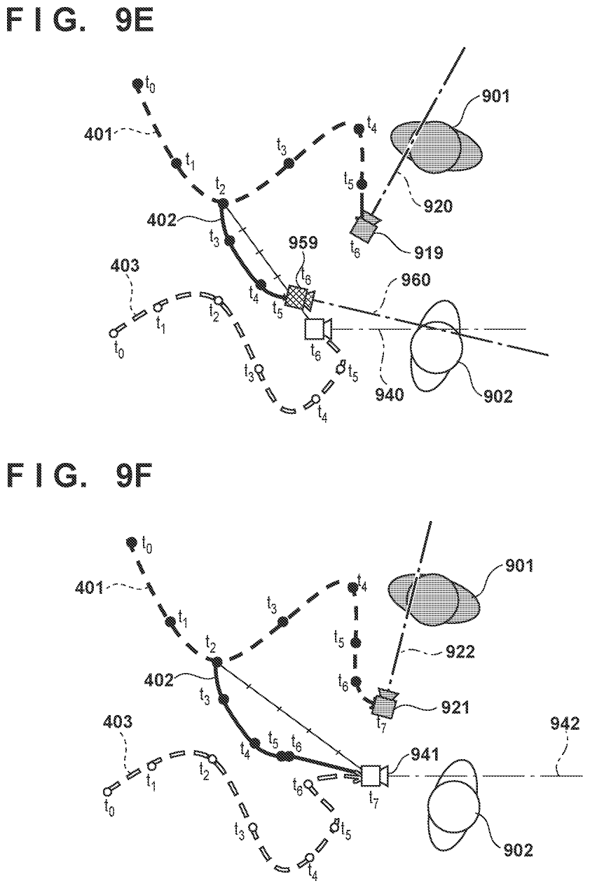

Further, the orientation of the second virtual camera may be calculated at a transition ratio that is different from the transition ratio for position so as to preferentially display the object included in the output video after switching. FIGS. 9A to 9F illustrate an example of processing of generating information on the virtual camera in step S802 so as to preferentially display the object included in the output video after switching. The position and orientation of each of the first virtual camera, the second virtual camera, and the real camera 112 at respective times are as illustrated in FIG. 4A. In the first virtual camera, an object 901 is present in the image capturing range as an object to be mainly captured, and in the real camera 112, an object 902 is present in the image capturing range as an object to be mainly captured. In the transition period for position (from times t2 to t7), the position of the second virtual camera transitions from the position of the first virtual camera to the position of the real camera 112 in the same manner as in the first embodiment. Meanwhile, between times t2 to t4, which is the transition period for orientation, the orientation and focal distance (zoom value) of the second virtual camera are drastically changed so as to have the same angle of view as the real camera 112. Then, between times t4 to t7, the orientation and focal distance of the second virtual camera are set so as to have the same angle of view as the real camera 112. The same angle of view refers to the orientation and angle of view that are set such that the same object is captured at substantially the same position in a video obtained from each viewpoint. Alternatively, it refers to the orientation and angle of view that are set such that the same object is captured to be substantially the same size in a video obtained from each viewpoint. Alternatively, it refers to the orientation and angle of view that are set such that the same object is captured at substantially the same position and to be substantially the same size in a video obtained from each viewpoint.

The object identification unit 701 can confirm at which position of the virtual viewpoint video obtained by the first virtual camera the foreground is present based on the information on the position, the orientation, and the focal distance of the first virtual camera from the virtual camera generation unit 110 and the position of the foreground from the 3D model storage unit 109. Similarly, the object identification unit 701 can confirm at which position of the real camera video captured by the real camera 112 the foreground is present based on the information on the position, the orientation, and the focal distance of the real camera 112 and the position of the foreground from the 3D model storage unit 109. During the transition period in which the virtual viewpoint video is outputted by the second virtual camera, the automatic generation unit 117 of the present embodiment calculates the orientation of the second virtual camera as if capturing, from the second virtual camera, a video having the same angle of view as the video after switching, that is, the video of the real camera 112.

FIG. 9A illustrates a position 911 and an orientation 912 of the first virtual camera at time t2 and a position 931 and an orientation 932 of the real camera 112 at time 2. At time t2, the position and the orientation of the second virtual camera are the same as the position 931 and the orientation 932 of the first virtual camera. FIG. 9B illustrates a position 913 and an orientation 914 of the first virtual camera, a position 933 and an orientation 934 of the real camera 112, and a position 951 and an orientation 954 of the second virtual camera at time t3. The orientation 954 of the second virtual camera at time t3 is decided based on the orientation 912 (an orientation 952) of the first virtual camera at time t2 and an orientation 953 at which the second virtual camera can obtain the same angle of view as the real camera 112 at time t3. That is, the orientation 954 of the second virtual camera at the time t3 is an orientation that has been inclined from the orientation 952 to the orientation 953 by a ratio of (t3−t2)/(t4−t2) between the orientation 952 and the orientation 954.

FIG. 9C illustrates a position 915 and an orientation 916 of the first virtual camera, a position 935 and an orientation 936 of the real camera 112, and a position 955 and an orientation 956 of the second virtual camera at time 14. As in the case of time t3, the orientation 956 of the second virtual camera at time t4 is decided based on the orientation 912 of the first virtual camera at time t2 and the orientation at which the second virtual camera can obtain the same angle of view as the real camera 112 at time t4. However, at time t4, since (t4−t2)/(t4−t2)=1, an orientation 956 at which the same angle of view as the real camera 112 can be obtained is decided to be an orientation of the second virtual camera at time t4.

FIG. 9D illustrates a position 917 and an orientation 918 of the first virtual camera, a position 937 and an orientation 938 of the real camera 112, and a position 957 and an orientation 958 of the second virtual camera at time t5. The orientation 958 of the second virtual camera at time t5 is decided so as to be able to obtain the same angle of view as the real camera 112 at time t5. Similarly, FIG. 9E illustrates a position 919 and an orientation 920 of the first virtual camera, a position 939 and an orientation 940 of the real camera 112, and a position 959 and an orientation 960 of the second virtual camera at time t6. The orientation 960 of the second virtual camera at time t6 is decided so as to be able to obtain the same angle of view as the real camera 112 at time t6. FIG. 9F illustrates a position 921 and an orientation 922 of the first virtual camera at time t7 and a position 941 and an orientation 942 of the real camera 112. At time t7, the position and the orientation of the second virtual camera are the same as the position 941 and the orientation 942 of the real camera 112.

<Variation>

In the above embodiments, the real camera 112 has been described as a camera that is brought into the vicinity of the image capturing range of the virtual viewpoint video, which is different from the camera group 101 for generating the virtual viewpoint video, but the present disclosure is not limited to this. For example, as in the second embodiment, the real camera 112 may be one of the cameras of the camera group 101 as long as the videos of some or all of the cameras of the camera group 101 are sent to the video switching unit 115 and can be selected as the output video. Thus, even when switching from the virtual viewpoint video to the real camera video by the real camera, which is one of the cameras of the camera group 101 for generating a virtual viewpoint video, it is possible to easily generate a new virtual viewpoint video for the transition period in which those videos are switched.

The generation of the virtual viewpoint in the transition period may be performed for each image capturing frame of the real camera 112 (or for each frame of the virtual viewpoint video by the first virtual viewpoint) during the transition period or may be performed at predetermined time intervals (such as every 0.5 seconds, for example).

As described above, by virtue of each of the above-described embodiments, an unnatural change in a video for when two videos are outputted by being switched is reduced.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-089463, filed May 27, 2021 which is hereby incorporated by reference herein in its entirety.

What is claimed is:

1. An image processing apparatus comprising:
one or more memories configured to store instructions; and
one or more processors configured to, upon executing the instructions:
obtain information on a first video and a second video at least one of which is a captured video obtained by an image capturing apparatus, the information related to the first video including information on a first viewpoint corresponding to the first video, and the information related to the second video including information on a second viewpoint corresponding to the second video at a timing that corresponds to a timing of the first video;
in a case where switching a video to be outputted from the first video to the second video, generate information on a virtual viewpoint corresponding to a period from an end of output of the first video until a start of output of the second video, based on the obtained information on the first viewpoint corresponding to the period and the obtained information on the second viewpoint corresponding to the period;
generate a virtual viewpoint video based on the generated information on the virtual viewpoint; and
output the first video, the generated virtual viewpoint video, and the second video in that order.

2. The image processing apparatus according to claim 1, wherein at a time the period starts, the information on the virtual viewpoint corresponding to the period is generated only based on the information on the first viewpoint.

3. The image processing apparatus according to claim 1, wherein the information on the virtual viewpoint corresponding to the period is generated based on the information on the first viewpoint, the information on the second viewpoint, and a ratio of an elapsed time from when the period started to a total time of the period.

4. The image processing apparatus according to claim 1, wherein
the one or more processors are further configured to, upon executing the instructions: set a ratio in accordance with a user operation received during the period, and
the information on the virtual viewpoint corresponding to the period is generated based on the information on the first viewpoint, the information on the second viewpoint, and the set ratio.

5. The image processing apparatus according to claim 3, wherein the information on the virtual viewpoint corresponding to the period is generated by taking a weighted-average of the information on the first viewpoint and the information on the second viewpoint, based on the ratio.

6. The image processing apparatus according to claim 1, wherein in the generation of the information on the virtual viewpoint corresponding to the period, a virtual viewpoint at each time during the period is generated based on the information on the first viewpoint at a time the period starts and the information on the second viewpoint at each time.

7. The image processing apparatus according to claim 1, wherein in the generation of the information on the virtual viewpoint corresponding to the period, a virtual viewpoint at each time during the period is generated based on the information on the first viewpoint at each time and the information on the second viewpoint at each time.

8. The image processing apparatus according to claim 1, wherein
the one or more processors are further configured to, upon executing the instructions: specify an object from a video that has been captured from the second viewpoint, and
in the generation of the information on the virtual viewpoint corresponding to the period, information on a direction of a view that is included in the information on the virtual viewpoint corresponding to the period is generated based on a position of the specified object.

9. The image processing apparatus according to claim 8, wherein in the generation of the information on the virtual viewpoint corresponding to the period, the information on the direction of the view that is included in the information on the virtual viewpoint corresponding to the period is generated based on a direction of a view of the virtual viewpoint for obtaining a video whose image capturing range is such that a position of the object that is captured in a virtual viewpoint video is the same as a position of the object that is captured in a video obtained from the second viewpoint, and a direction of a view of the first viewpoint at the start of the period.

10. The image processing apparatus according to claim 8, wherein in the generation of the information on the virtual viewpoint corresponding to the period, information on a focal distance of the virtual viewpoint corresponding to the period is generated based on a focal distance of a view of the virtual viewpoint for obtaining a video whose image capturing range is such that a size of the object that is captured in a virtual viewpoint video is the same as a size of the object that is captured in a video obtained from the second viewpoint, and a focal distance of a view of the first viewpoint at the start of the period.

11. The image processing apparatus according to claim 1, wherein one of the first video and the second video is a virtual viewpoint video that is generated based on a plurality of images that have been captured by a plurality of image capturing apparatuses and a virtual viewpoint.

12. The image processing apparatus according to claim 11, wherein
the one or more processors is further configured to, upon executing the instructions: connect with the plurality of image capturing apparatuses that obtain the plurality of images, and
the virtual viewpoint video of the period is generated based on the plurality of images.

13. The image processing apparatus according to claim 12, wherein the image capturing apparatus is one of the plurality of image capturing apparatuses.

14. A method of controlling an image processing apparatus, the method comprising:
obtaining information on a first video and a second video at least one of which is a captured video obtained by an image capturing apparatus, the information related to the first video including information on a first viewpoint corresponding to the first video, and the information related to the second video including information on a second viewpoint corresponding to the second video at a timing that corresponds to a timing of the first video;
in a case where switching a video to be outputted from the first video to the second video, generating information on a virtual viewpoint corresponding to a period from an end of output of the first video until a start of output of the second video, based on the obtained information on the first viewpoint corresponding to the period and the obtained information on the second viewpoint corresponding to the period;
generating a virtual viewpoint video based on the generated information on the virtual viewpoint; and
outputting the first video, the generated virtual viewpoint video and the second video in that order.

15. A non-transitory computer-readable storage medium operable to store a program for causing a computer to execute a method of controlling an image processing apparatus, the method comprising:
obtaining information on a first video and a second video at least one of which is a captured video obtained by an image capturing apparatus, the information related to the first video including information on a first viewpoint corresponding to the first video, and the information related to the second video including information on a second viewpoint corresponding to the second video at a timing that corresponds to a timing of the first video;
in a case where switching a video to be outputted from the first video to the second video, generating information on a virtual viewpoint corresponding to a period from an end of output of the first video until a start of output of the second video, based on the obtained information on the first viewpoint corresponding to the period and the obtained information on the second viewpoint corresponding to the period,
generating a virtual viewpoint video based on the generated information on the virtual viewpoint; and
outputting the first video, the generated virtual viewpoint video, and the second video in that order.
